(19) United States
(12) Patent Application Publication
(10) Pub. No.: US 2015/0046304 A1
(43) Pub. Date: Feb. 12, 2015

(54) ANALYSIS OF E-RECEIPTS FOR CHARITABLE DONATIONS

(71) Applicant: Bank of America Corporation, Charlotte, NC (US)

(72) Inventors: Laura C. Bondesen, Charlotte, NC (US); Jason P. Blackhurst, Charlotte, NC (US); Matthew A. Calman, Charlotte, NC (US); Katherine Dintenfass, Charlotte, NC (US); Carrie Anne Hanson, Charlotte, NC (US)

(73) Assignee: Bank of America Corporation, Charlotte, NC (US)

(21) Appl. No.: 13/963,507

(22) Filed: Aug. 9, 2013

(51) Int. Cl. G06Q 40/00

(52) U.S. Cl. CPC G06Q 40/10; G06Q 40/00
USPC 705/31; 705/35

(57) ABSTRACT

Embodiments of the invention are directed to apparatus, methods, and computer program products for analyzing transaction item-identifying data, such as e-receipts, for the purpose of identifying which transactions or items in a transaction qualify as charitable contributions and in some embodiments verifying or confirming that the transaction or items in the transaction are charitable contributions for the purpose of tax deductions. Additionally, the invention may determine the items and/or portion of the overall or item purchase amount that qualifies as a charitable contribution for tax deductions purposes. In addition, the invention provides for automatically communicating verified charitable contribution information to a third party or database that will insure that the charitable contribution receives consideration when the customer's income tax filings are prepared.

### FIELD

In general, embodiments of the invention relate to methods, systems, apparatus and computer program products for data analysis and, more particularly, for automated item-level determination of charitable contributions in transaction item-identifying data, such as e-receipts.

### BACKGROUND

There has been recent growth in online banking, mobile banking and the like, whereby financial institution customers, (such as bank and credit card customers), may view financial account transaction data, perform online payments and money transfers, view account balances, and the like. Many current online banking applications are fairly robust and provide customers with budgeting tools, financial calculators, and the like to assist the customer to not only perform and view financial transaction date, but also to manage finances. A current drawback with online banking is that transactional level detail for a given purchase by the customer is limited. Despite the large amount of information sent by merchants to customers regarding purchases, merchants currently do not provide purchase details to financial institutions. The only information provided by the merchant to the financial institution is information about the merchant and an overall transaction amount. For example, if a financial institution customer purchases several clothing items from a merchant and uses a financial institution debit card, credit card or check, all that is provided to the financial institution is the merchant information and overall purchase amount. Product level detail that is present on the receipt provided to the customer by the merchant is not provided to the financial institution.

The lack of detailed information regarding a given transaction in the online banking environment limits a customer's ability to ascertain a larger picture of purchase history and financial transaction information. Specific to this inability to receive information regarding a given transaction is the inability to identify which transactions, and more specifically which items in a transaction qualify as charitable contributions.

Therefore, a need exists to analyze transaction item-identifying data, such as e-receipts or the like for the purpose of identifying and verifying which transactions and/or items in a transaction qualify as charitable contributions. In addition to identifying and verifying which transactions and/or items qualify for charitable contributions a need exists to determine the portion of the purchase amount that qualifies as a charitable contribution for tax deductions purposes and a need exists to automatically communicate such information to a third party or database that will insure that the charitable contribution receives consideration when preparing income tax filings.

### BRIEF SUMMARY

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention relate to systems, apparatus, methods, and computer program products for analyzing transaction item-identifying data, such as e-receipts or the like for the purpose of identifying and verifying which transactions and/or items in a transaction qualify as charitable contributions. In addition to identifying and verifying which transactions and/or items qualify for charitable contributions specific embodiments of the present invention determine the portion of the purchase amount that qualifies as a charitable contribution for tax deductions purposes. Moreover, other specific embodiments of the invention provide for automatically communicating verified charitable contribution information to a third party or database that will insure that the charitable contribution receives consideration when the customer's income tax filings are prepared.

An apparatus for automatically identifying charitable contributions in transaction item-identifying data defines first embodiments of the invention. The apparatus includes a computing platform having a memory and at least one processor in communication with the memory device. The apparatus further includes an aggregation and structuring application is stored in the memory, executable by the processor and configured to receive transaction item-identifying data in an unstructured format. The transaction item-identifying data is associated with a transaction conducted by a customer. Further, the aggregation and structuring application is configured to structure the transaction item-identifying data for financial institution compatibility.

The apparatus additionally includes a charitable contribution determination application stored in the memory, executable by the processor and configured to determine, from the structured transaction item-identifying data, that the transaction or one or more items in the transaction qualify as charitable contributions and store a charitable contribution identifier in a database associated with the transaction.

In alternate embodiments of the apparatus, the aggregation and structuring application is further configured to receive an e-receipt corresponding to the transaction conducted by the identified customer. The e-receipt includes one or more unique identifiers (e.g., a Stock Keeping Unit (SKU) or the like) each of which identify the one or more items in the transaction. In further related embodiments of the apparatus, the aggregation and structuring application is further configured to crawl an email account held by the identified customer to identify and collect e-receipts received by the identified customer.

In specific embodiments of the apparatus, the charitable contribution determination application is further configured to determine that the structured transaction item-identifying data includes a charitable contribution indicator, such key words/phrases in an e-receipt or the like.

In other specific embodiments the apparatus includes a charitable contribution confirmation application stored in the memory, executable by the processor and configured to access a charitable entity database to attempt to confirm the tax-deductible status of the charitable contribution. In such embodiments the apparatus may further include a charitable contribution alert application stored in the memory, executable by the processor and configured to, in response to confirming or failing to confirm the tax-deductible status of the charitable contribution, generate and initiate communication of an alert to the customer, wherein the alert is configured to notify the customer that the charitable contribution is confirmed or unconfirmed.

In still further specific embodiments of the apparatus, the charitable contribution determination application is further configured to determine which of the one or more items in the transaction qualify as charitable contributions. While in other related embodiments of the apparatus, the charitable contribution determination application is further configured to determine an amount of the transaction that qualifies as a charitable contribution.

In further embodiments the apparatus includes a personal finance management application that is stored in the memory, executable by the processor and configured to provide charitable contribution transaction filtering, wherein the filtering is configured to provide a view of which transactions qualify as charitable contributions as determined from the structured transaction item-identifying data. In such embodiments, the views may include highlighted fields that indicate unconfirmed charitable contributions and/or fields having missing data

In still further embodiments of the invention, the charitable contribution determination application is further configured to communicate the transaction item-identifying data associated with the charitable contribution to at least one of an income tax database/application or an income tax advisor.

Moreover, in further embodiments of the apparatus, the charitable contribution determination application is further configured to determine a tax savings realized by the charitable contribution based on an amount of the charitable contribution, an income of the customer and a tax rate of the customer.

A method for automatically identifying charitable contributions in transaction item-identifying data defines second embodiments of the invention. The method includes receiving, in an unstructured format, transaction item-identifying data that is associated with a transaction conducted by a customer and structuring the transaction item-identifying data for financial institution compatibility. Such structuring may include one or more of parsing the data using a predetermined template and/or re-formatting the data to a financial institution compliant format. The method further includes determining, from the structured transaction item-identifying data, that the transaction or one or more items in the transaction qualify as charitable contributions and storing a charitable contribution identifier in a database associated with the transaction.

In alternate embodiments of the method, receiving the transaction item-identifying data further includes receiving an e-receipt corresponding to the transaction conducted by the identified customer. The e-receipt includes one or more unique identifiers each of which identify the one or more items in the transaction. In such embodiments the method may further include crawling an email account held by the identified customer to identify and collect e-receipts received by the identified customer.

In specific embodiments of the method, determining, from the structured transaction item-identifying data, that the transaction or one or more items in the transaction qualify as charitable contributions further includes determining that the structured transaction item-identifying data includes a charitable contribution indicator.

In still further specific embodiments the method includes accessing, by a computing device processor, a charitable entity database to attempt to confirm the tax-deductible status of the charitable contribution. In such embodiments the method may include, in response to confirming or failing to confirm the tax-deductible status of the charitable contribution, generating and initiating communication of an alert that is configured to notify the customer that the charitable contribution is confirmed or unconfirmed.

In additional embodiments the method includes determining which of the one or more items in the transaction qualify as charitable contributions. While in other related embodiments the method includes determining an amount of the transaction that qualifies as a charitable contribution.

Moreover, in other specific embodiments the method includes providing, within a network-accessible financial institution application, charitable contribution transaction filtering. The filtering is configured to provide a view of which transactions qualify as charitable contributions as determined from the structured transaction item-identifying data.

In yet another alternate embodiment the method includes communicating the transaction item-identifying data associated with the charitable contribution to at least one of an income tax database/application or an income tax advisor.

In still further embodiments the method includes determining a tax savings realized by the charitable contribution based on an amount of the charitable contribution, an income of the customer and a tax rate of the customer.

A computer program product including a non-transitory computer-readable medium defines third embodiments of the invention. The computer-readable medium includes a first set of codes for causing a computer to receive, in an unstructured format, transaction item-identifying data that is associated with a transaction conducted by a customer and a second set of codes for causing a computer to structure the transaction item-identifying data for financial institution compatibility. The computer-readable medium additionally includes a third set of codes for causing a computer to determine, from the structured transaction item-identifying data, that the transaction or one or more items in the transaction qualify as charitable contributions, and a fourth set of codes for causing a computer to store a charitable contribution identifier in a database associated with the transaction.

Thus, embodiments of the present invention, which are described in more detail below, provide for analyzing transaction item-identifying data, such as e-receipts or the like for the purpose of identifying which transactions and/or items in a transaction qualify as charitable contributions. In addition to identifying which transactions and/or items qualify for charitable contributions specific embodiments of the present invention confirm that the charitable contribution is tax-deductible. Moreover additional embodiments of the invention determine the items and/or portion of the overall or item purchase amount that qualifies as a charitable contribution for tax deductions purposes. Additionally, the invention provides for automatically communicating verified charitable contribution information to a third party or database that will insure that the charitable contribution receives consideration when the customer's income tax filings are prepared. In this regard the present invention fully automates identification and of charitable contributions, verification/confirmation of such charitable contributions as being tax-deductible and insures that notification of such is communicated to customer designated entities that will insure inclusion of such in forthcoming income tax filings.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 is a schematic diagram representation of an operating environment for retrieval of electronic communications relating to customer purchase transactions, parsing of data within such electronic communications into structured data, formatting the data for financial institution accessibility and inclusion of such data into a network-accessible financial institution application, in accordance with embodiments of the present invention;

FIG. 2 is a block diagram of an apparatus for analyzing transaction item-identifying data, such as receipts or the like to automatically identify charitable contributions, in accordance with embodiments of the present invention;

FIG. 3 is a more detailed block diagram of an apparatus for analyzing transaction item-identifying data, such as receipts or the like to automatically identify charitable contributions, in accordance with embodiments of the present invention;

FIG. 4 is a flow diagram of a method for analyzing transaction item-identifying data, such as receipts or the like to automatically identify charitable contributions, in accordance with embodiments of the present invention; and

FIG. 5 is a schematic diagram of an operating environment for analyzing transaction item-identifying data, such as receipts or the like to automatically identify charitable contributions, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

Furthermore, the term “product” or “account” as used herein may include any financial product, service, or the like that may be provided to a customer from an entity that subsequently requires payment. A product may include an account, credit, loans, purchases, agreements, or the like between an entity and a customer. The term “relationship” as used herein may refer to any products, communications, correspondences, information, or the like associated with a customer that may be obtained by an entity while working with a customer. Customer relationship data may include, but is not limited to addresses associated with a customer, customer contact information, customer associate information, customer products, customer products in arrears, or other information associated with the customer's one or more accounts, loans, products, purchases, agreements, or contracts that a customer may have with the entity.

Although some embodiments of the invention herein are generally described as involving a “financial institution,” one of ordinary skill in the art will appreciate that other embodiments of the invention may involve other businesses that take the place of or work in conjunction with the financial institution to perform one or more of the processes or steps described herein as being performed by a financial institution. Still in other embodiments of the invention the financial institution described herein may be replaced with other types of businesses that utilized accounts in arrears recovery.

Thus, the present invention herein disclosed in greater detail below, provides for analyzing transaction item-identifying data, such as e-receipts and the like, to determine transactions and/or specific items in transactions that qualify as charitable contributions. In additional embodiments the charitable contributions may be verified or confirmed as being charitable contributions for the purpose of tax deductions. Additionally, the invention provides for automatically communicating verified charitable contribution information to a third party or database that will insure that the charitable contribution receives consideration when the customer's income tax filings are prepared. In this regard the present invention fully automates identification and of charitable contributions, verification/confirmation of such charitable contributions as being tax-deductible and insures that notification of such is communicated to customer designated entities that will insure inclusion of such in forthcoming income tax filings.

In the past few years, there has been an increase in the amount of electronic information provided by merchants to customers regarding purchase of products and services. In the online purchase context, various electronic communications may be provided to the customer from the merchant relative to a purchase. For example, following an online purchase, the merchant may provide the customer an electronic order confirmation communication. The order confirmation may be sent to the customer's computer and displayed in a web browser application. The web browser application typically allows the customer to print a hard copy of the order confirmation and to save the confirmation electronically. The merchant will also typically send an email containing the order confirmation to the customer's designated email account. The order confirmation is otherwise referred to as an electronic receipt, commonly referred to as an e-receipt, for the online purchase. The order confirmation includes detailed information regarding the products or services purchased. For example, in the case of a product, the order confirmation may include stock keeping unit “SKU” code level data, as well as other parameters, such as an order number, an order date, a product description, a product name, a product quantity, a product price, a product image, a product image or a hyperlink to the product image on a merchant website, the sales tax incurred, the shipping cost incurred, an order total, a billing address, a third party shipping company, a shipping address, an estimated shipping date, an estimated delivery date, a shipment tracking number, and the like. The order confirmation also includes information about the merchant, such as the name of the merchant, the address of the merchant, a telephone number of the merchant, a web address, and the like. For most online transactions, the merchant will send at least one second communication confirming shipment of the order. The order shipment confirmation is typically also sent via email to the customer and typically includes the same information as the order confirmation, and in addition, a shipping date, a shipment tracking number, and other relevant information regarding the order and shipment parameters.

Many merchants now also provide the option for customers to receive e-receipts when shopping at “brick and mortar” locations (i.e., physical locations). In general, at the point of sale, the customer may have previously configured or may be asked at the time of sale as to whether he or she wishes to receive an e-receipt. By selecting this option, the merchant will send an electronic communication in the form of an e-receipt to the customer's designated email address. Here again, the e-receipt will typically include a list of services and/or products purchased with SKU level data, and other parameters, as well as information about the merchant, such as name, address, phone number, store number, web address, and the like.

Various merchants now also provide online customer accounts for repeat customers. These online customer accounts may include purchase history information associated with the customer, which are accessible by the customer via ID and passcode entry. Purchase history provides detailed information about services and products purchased by the customer including information found on order confirmations and shipping confirmations for each purchase. Online customer accounts are not limited to online purchases. Many merchants also provide online customer accounts for customers that purchase services and products at “brick and mortar” locations and then store these transactions in the customer's online account.

For the most part, order confirmations, shipping confirmations, e-receipts, and other electronic communications between merchants and customers are used only by the customer as proof-of-purchase and for monitoring receipt of purchased items (i.e., for archival purposes). However, there is significant data that can be gleaned from this electronic information for the benefit of the customer, so that the customer may have detailed information regarding purchase history, spending, and the like.

Another development in the past few years has been the growth of online banking, mobile banking and the like, whereby financial institution customers, (such as bank and credit card customers), may view financial account transaction data, perform online payments and money transfers, view account balances, and the like. Many current online banking applications are fairly robust and provide customers with budgeting tools, financial calculators, and the like to assist the customer to not only perform and view financial transaction date, but also to manage finances. A current drawback with online banking is that transactional level detail for a given purchase by the customer is limited. Despite the large amount of information sent by merchants to customers regarding purchases, merchants currently do not provide purchase details to financial institutions. The only information provided by the merchant to the financial institution is information about the merchant and an overall transaction amount. For example, if a financial institution customer purchases several clothing items from a merchant and uses a financial institution debit card, credit card or a check, all that is provided to the financial institution is the merchant information and overall purchase amount. Product level detail that is present on the receipt provided to the customer by the merchant is not provided to the financial institution.

The lack of detailed information regarding a given transaction in the online banking environment limits a customer's ability to ascertain a larger picture of purchase history and financial transaction information. As a first example, if a customer makes several purchases within a short time period with a particular merchant, all that the customer will see in online banking for each purchase is an overall dollar amount, the merchant name, and date of the purchase transaction. If the customer cannot recall, what a particular purchase was for or whether it was a legitimate transaction, the customer cannot view details regarding the purchase via online banking to aid in the inquiry. Instead, the customer must locate and review receipts from the purchases and match them by date and/or total purchase amount to online banking data to perform such analysis.

Lack of detailed purchase information also hinders use of other financial tools available to the customer in online banking, such as budgetary tools. In general, budgetary tools divide expenses into various categories, such as food, clothing, housing, transportation, and the like. It is typically advantageous to provide such budget tools with online banking information to populate these various categories with spend information. However, this is difficult where specifics regarding a purchase made by the merchant (such as SKU level data) are not provided by the merchant to the financial institution for a given financial transaction. As many stores provide a wide variety of services and products, such as in the case of a “big box” store that provides groceries, clothing, house hold goods, automotive products, and even fuel, it is not possible to dissect a particular purchase transaction by a customer at the merchant for budget category purposes. For this reason, many current online budgeting tools may categorize purchases for budgeting by merchant type, such as gas station purchases are categorized under transportation and grocery store purchases are categorized under food, despite that in reality, the purchase at the gas station may have been for food or the purchase at the grocery store could have been for fuel. Alternatively, some budget tools may allow a customer to parse the total amount of a purchase transaction between budget categories by manually allocating amounts from the purchase transaction between each budget category. This requires added work by the customer and may be inaccurate, if the customer is not using the receipt in making such allocations or the customer fails to recall exactly what items were purchased in previous transactions.

Traditional cash purchases are also problematic for integration of customer purchase transactions into online banking. In a cash transaction, the customer may initially withdraw cash from a financial account and then use the money for a purchase. In this instance, the customer's online banking will have no information whatsoever regarding the purchase transaction with a merchant, as there is no communication regarding the purchase transaction between the financial institution and the merchant. For example, if the customer uses cash to purchase fuel at a gas station, the financial institution has no way of determining that the purchase transaction occurred and cannot use such information for notifying the customer of spending or budgeting regarding the fuel purchase.

As described above, currently financial institutions are not provided with detailed transaction level information regarding a purchase transaction by a customer from a merchant beyond merchant information and overall transaction price for inclusion in online banking. While detailed data (such as SKU level data) is provided to the customer via receipts, such information is not provided by the merchant to the financial institution. The information is available to the customer but not integratable into a customer's online banking for efficient and increased beneficial use of the information. Currently, a customer must retain her receipts and manually compare such receipts with online purchase transaction data and manually input related data into online banking to obtain an understanding of the details of a given purchase transaction.

In light of the above, the current invention contemplates use of purchase confirmation or e-receipt data and other electronic communication data between a merchant and customer regarding a transaction (referred to herein as transaction item-identifying data) in order to augment purchase transaction data in online banking, mobile banking and the like. The general concept is to retrieve such electronic communications from the customer, parse the data in these electronic communications, and associate the data from the electronic communications with the corresponding online purchase transaction data.

An initial barrier to integration of electronic communication data received by a customer from a merchant regarding a purchase transaction for inclusion into online banking is data format. Online banking data is in a structured form. Financial institutions currently use a data structure conforming to Open Financial Exchange “OFX” specifications for the electronic exchange of financial data between financial institutions, businesses and customers via the Internet. E-receipts, such as electronic order confirmations, shipment confirmation, receipts, and the like typically do not comply to a uniform structure and are generally considered to include data in an “unstructured” format. For example, while one merchant may provide data in an electronic communication to a customer in one format, another merchant may use a completely different format. One merchant may include merchant data at the top of a receipt and another merchant may include such data at the bottom of a receipt. One merchant may list the purchase price for an item on the same line as the description of the item and list the SKU number on the next line, while another merchant may list the data in a completely opposite order. As such, prior to integration of electronic communications relating to customer purchases into online banking, the data from such electronic communications must be parsed into a structured form.

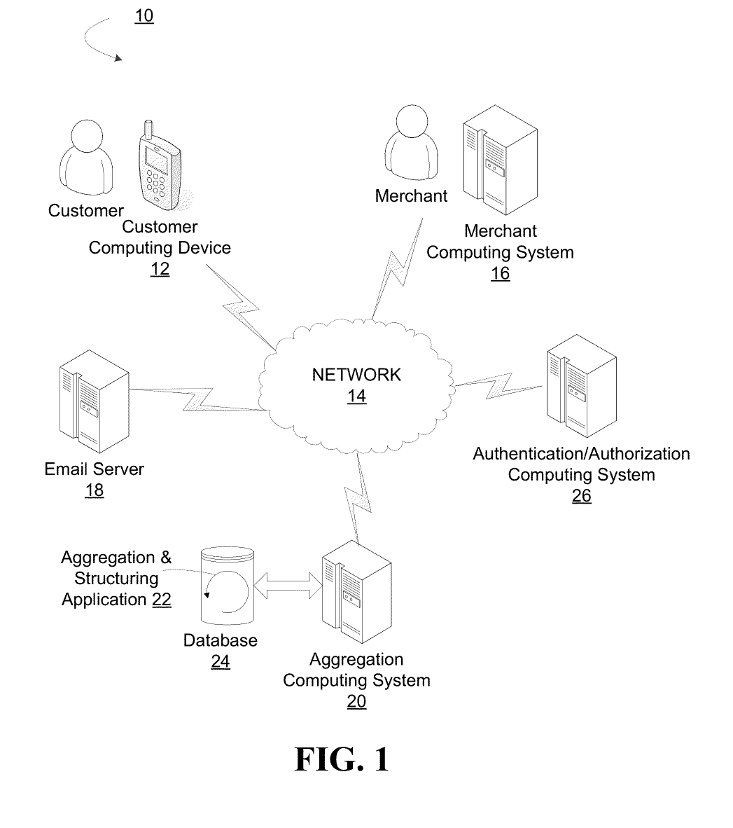

FIG. 1 is a diagram of an operating environment 10 according to one embodiment of the present invention for retrieval of electronic communications relating to customer purchase transactions, parsing of data within such electronic communications into structured data, formatting the data for financial institution accessibility and inclusion of such data into a network-accessible banking application, such as online or mobile banking. As illustrated a consumer maintains one or more computing devices 12, such as a PC, laptop, mobile phone, tablet, television, or the like that is network accessible for communicating across a network 14, such as the Internet, wide area network, local area network, short range/near field network, or any other form of contact or contactless network. Also, in the operating environment, is one or more merchant computing systems 16 that is network accessible. In the context of an online shopping experience, the merchant computing system 16 may be one or more financial transaction servers that, either individually or working in concert, are capable of providing web pages to a customer via the network 14, receiving purchase orders for items selected by the customer, communicating with the customer and third party financial institutions to secure payment for the order, and transmitting order confirmation, and possibly shipping confirmation information, to the customer via the network 14 regarding the purchase transaction. In the context of an in-store purchase, the merchant computing system 16 may include a point of sale terminal for scanning or receiving information about products or services being purchased by the customer and communicating with the customer and third party financial institutions to secure payment for the order. Either the point of sale device or a connected merchant server may be used to communicate order confirmation or purchase confirmation information (e.g., e-receipt) to the customer related to the purchase transaction. If the customer has an online account with the merchant, the merchant computing system may also log the transaction information into the customer's online account.

In general, the merchant computing system will provide the customer with information relating to the purchase transaction. In the context of an online purchase, the communications may take the form of purchase order confirmations provided as a web page or as an email or as both. In some, embodiments, the merchant computing system may provide a web page purchase order confirmation, and advise the customer to either print, electronically save, or book mark the confirmation web page. The purchase order confirmation is essentially an e-receipt for the online purchase transaction. The order confirmation includes detailed information regarding the products or services purchased, such as for example, in the case of a product, SKU code level data, as well as other parameters associated with the product, such as type/category, size, color, and the like, as well purchase price information, information associated with the merchant, and the like. The merchant computing system may also send other subsequent communications, such as communications confirming shipment of the order, which typically includes the same information as the purchase order confirmation, and in addition, shipping date, tracking number, and other relevant information regarding the order. In the context of an in-store purchase, the merchant computing system may send an e-receipt comprising information similar to that of the purchase order confirmation. In some instances, the customer may actually receive a paper receipt, which the customer may choose to scan into an electronic form and save in a storage device associated with the customer computing device 12. In the description herein, the term e-receipt may be used generically to refer to any communication or document provided by a merchant to a customer relating to a purchase transaction.

For a plurality of different purchase transactions, a customer may include purchase transaction item-identifying data (e.g., order confirmations, shipping confirmations, e-receipts, scanned receipts, typed or handwritten notes, invoices, bills of sale, and the like) in various locations and in various forms. The transaction item-identifying data could be stored in a storage device associated with the customer computing device 12, or in an email server 18, or in a customer's account at the merchant's computing system 16. Furthermore, as mentioned, the transaction item-identifying data is in an unstructured format. Each merchant may use a customized reporting format for the communications, whereby various data relating to the purchase transaction may be placed in different sequences, different locations, different formats, etc. for a given merchant. Indeed, a given merchant may even use different data formatting and structuring for different communications with the customer (e.g., order confirmation, shipping, confirmation, e-receipt, online customer account information, and the like).

To aggregate and structure data related to purchase transactions, the operating environment further comprises an aggregation computing system 20 including aggregation and structuring application 22 stored in database 24. The aggregation computing system 20 is operatively connected to at least one of the customer computing device 12, the merchant computing system 16, and the email server 18 via the network 14. The aggregation and structuring application 22 is configured to initially crawl (i.e., search and locate) electronic communications associated with purchase transactions made by the customer, in for example, the customer's email, computer storage device, online accounts, and the like. For this purpose, the system may optionally include an authentication/authorization computing system 26 that comprises security IDs and passwords and other security information associated with the customer for accessing customer's email, storage devices, and customer online accounts.

Regarding email extraction, aggregation and structuring application 22 initially gains access to the customer's email accounts and retrieves email message headers comprising data fields relative to the email message, such as sender, subject, date/time sent, recipient, and the like. In some embodiments, the aggregation computing system accesses the emails directly. In other embodiments, the aggregation computing system may run search queries of the email database based on known merchant names and/or phrases associated with e-receipt information, such as “receipt,” “order confirmation,” “shipping confirmation,” or the like. Once emails are extracted, further filtering may occur to locate relevant emails. Examples of further filtering may be searches based on known online merchants, third parties known to provide e-receipts, text in the email message subject line that corresponds to known order confirmation subject line text or known shipping confirmation subject line text, such as an email message sent with a subject line containing the text “purchase,” “order,” “ordered,” “shipment,” “shipping,” “shipped,” “invoice,” “confirmed,” “confirmation,” “notification,” “receipt,” “e-receipt,” “return,” “pre-order,” “pre-ordered,” “tracking,” “on its way,” “received,” “fulfilled,” “package,” and the like.

Based on the email header analysis, the message bodies for emails of interest may then be accessed. The retrieved email message bodies for the identified email messages of interest are parsed to extract the purchase transaction information and/or shipping information contained therein. Such parsing operation can occur in a variety of known ways. However, because the text included in email message bodies is unstructured (as opposed to the structured tagged elements in a hypertext markup language (HTML) web page, which delineate and make recognizable the various fields or elements of the web page), in one embodiment predefined templates are used that have been specifically created to identify the various individual elements or entities of interest in a given email from an online merchant. Use of these predefined templates to parse a retrieved email message body occurs within aggregation and structuring application 22. Because it is known from header information which merchant sent the email message of interest and whether the email message is a purchase order confirmation or a shipping confirmation from either the header or the message body information, a template specific to the merchant and type of confirmation may be used. Still further, because email message bodies can, as is known in the art, be in either a text or HTML format, a template specific to the type of email message body format may be used in some embodiments.

As an example, for each merchant there are typically four different parsing templates which can be used for electronic communications relating to purchase transactions: i) a text order confirmation template; ii) an HTML order confirmation template; iii) a text shipping confirmation template; and iv) an HTML shipping confirmation template. In instances in which the email is an e-receipt from a “brick and mortar” purchase, another template may be used that is specific to the merchant. For some online merchants there are greater or fewer templates depending upon what are the various forms of email messages a given online merchant typically sends. Regardless of the number of templates for a given merchant, each template is specific as to the known particular entities typically included and the order they typically occur within each type of email confirmation message sent by that merchant.

The above describes parsing of email purchase order confirmation, shipping confirmation, or e-receipt data. As mentioned, a customer may scan and save paper receipts, typed or printed notes, invoices, bills of sale, and the like in a storage device or print and save purchase order and shipping confirmation communications sent to the customer by the merchant via a web page. In this instance, the aggregation and structuring application 22 may first perform optical character recognition “OCR” on the scanned or printed receipts prior to perform the processing performed above. Further, a customer may maintain an online account with a merchant containing purchase data information. In this instance, the aggregation computing system 20 will access the data online via communication with merchant computing system to retrieve this data. The aggregation computing system 20 may use column and/or row headers associated with the online data to parse the data, or it may use procedures similar to the above and discussed below to parse the data into appropriate fields.

Returning to data processing procedures, in some embodiments, context-free grammars “CFGs” are used to parse fields from purchase transaction data. In some embodiments, instead of using grammars for parsing natural language (e.g., English) structures, the system may use defined smaller grammars describing a particular message format, for example: “(Greetings from merchant)(Details about order)(Details about item 1)(Details about item 2) . . . (Details about item N)(Tax and totals calculation),” and the like. Further, the CFGs may be individually defined, such as in a Backus-Naur Form (BNF) format, or templates may be used for data extraction. In instances, where templates are used, these created templates are grammar and can be converted by known tools, such as Another Tool for Language Recognition “ANTLR”, into mail-specific grammars or e-receipt-specific grammars or online customer account information-specific grammars. ANTLR is then used again to convert these grammars into extraction parsers, which can be used by the aggregation computing system 20 to parse the email message bodies, e-receipt bodies, online data, etc. to extract the entities of interest from them. Examples of such extracted entities include merchant name, merchant web address, order number, order date, product description, product name, product quantity, product price, product image, hyperlink to the product image on merchant website, sales tax, shipping cost, order total, billing address, shipping company, shipping address, estimated shipping date, estimated delivery date, tracking number, and the like.

Once the data has been properly parsed, the data may be required to be formatted to conform to financial institution specifications. For example, as previously noted, the data may be formatted to conform to Open Financial Exchange “OFX” specifications for the electronic exchange of financial data between financial institutions, businesses and customers via the Internet.

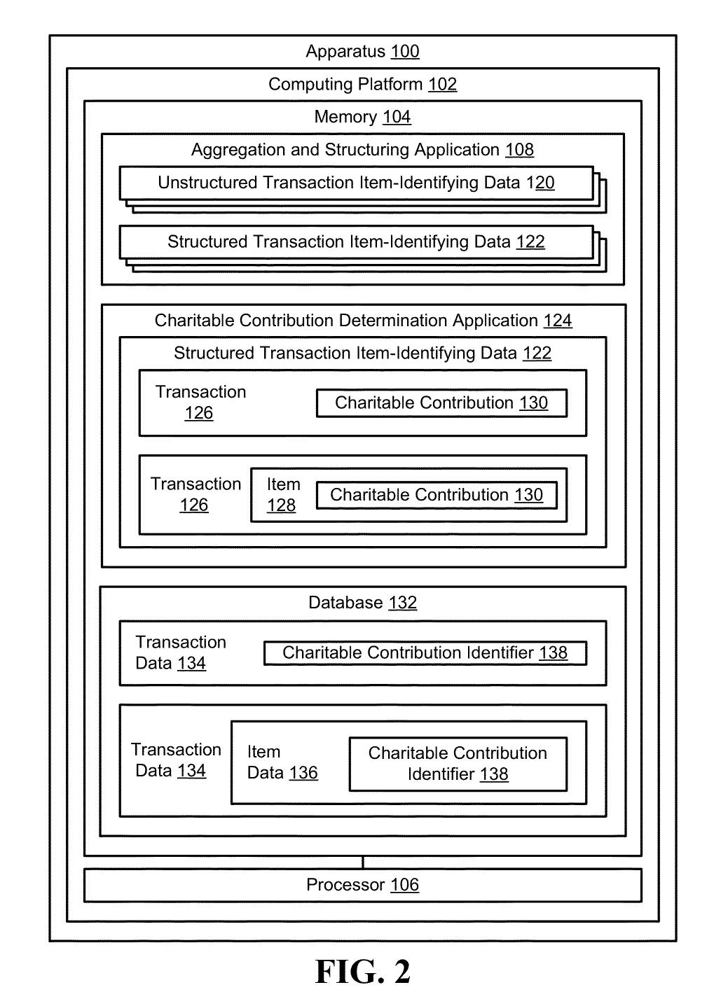

FIG. 2 provides a block diagram of an apparatus 100 configured for analyzing transaction item-identifying data, such as e-receipts or the like to determine that the transaction or items in the transaction qualify as charitable contributions, in accordance with embodiments of the present invention. The apparatus includes a computing platform 102 having a memory 104 and at least one processor 106 that is communication with the memory 104. The memory 104 of apparatus 100 stores aggregation and structuring application 108 that is executable by processor 106 and configured to receive unstructured transaction identifying-data 120, such as e-receipts, purchase confirmations, shipping confirmations, scanned receipts and the like, associated with transactions conducted by a customer, and process the data to result in structured transaction item-identifying data 122. The process of such data is described in detail in relation to FIG. 1 and may include crawling email accounts to collect e-receipts and the like from a customer's email account, parsing the transaction item-identifying data using predetermined templates to render item-identifying data and other relevant data from the e-receipts and the like, and formatting the data in a format accessible to financial institution systems, such as personal finance management systems (e.g., online banking, mobile banking and the like).

Memory 104 of apparatus 108 also includes charitable contribution determination application 124 that is executable by the processor 106 and configured to determine, from the structured transaction item-identifying data 122, that the transaction 126 or one or more of the items 128 in the transaction 126 is/are charitable contributions 130. In one embodiment keyword searches are applied to the structured transaction item-identifying database, such as e-receipt data (e.g., purchase confirmations, shipping confirmations or the like) to identify transactions 126 or items 128 in transactions 126 that are charitable contributions 130. Such keywords may include, but are not limited to, “charity”, “charitable”, “contribution”, “non-profit organization” “tax-exempt”, “tax-deductible”, “501(C)” or the like. The keywords may be predetermined by the application and/or defined, added or modified by the user/customer. It should be noted that any portion of the original e-receipt may be found to include the keywords, including the body, the subject line, the from line or the like. In addition, users/customer may designate an e-receipt that otherwise does not indicate a charitable contribution (i.e., original e-receipt does not include any key words) as a charitable contribution by editing the subject line of the e-receipt to include a keyword(s) or forwarded the e-receipt back to the customer's own email address with comments (in the subject line or email body) that indicate a charitable contribution (i.e., keyword(s) included).

In addition, memory 104 of apparatus 100 includes transaction database 132 that is configured to, in response to determine that a transaction or item(s) in a transaction structured transaction-item identifying data is/are charitable contributions, store a charitable contribution identifier 138 in conjunction with transaction data 134 associated with the transaction 126 that is a charitable contribution 130 or store individual charitable contribution identifiers 138 in conjunction with item data 136 for each item 128 in the transaction 126 that are charitable contributions. In such embodiment of the invention, the transaction database 132 is associated with a personal finance management application, such as online banking, mobile banking or the like. In such embodiments of the invention, a matching procedure may be necessary to match transactions existing in the personal finance management application (i.e., credit, checking transactions conducted by the customer) with the transaction associated with the transaction item-identifying data, e.g., the e-receipt or the like.

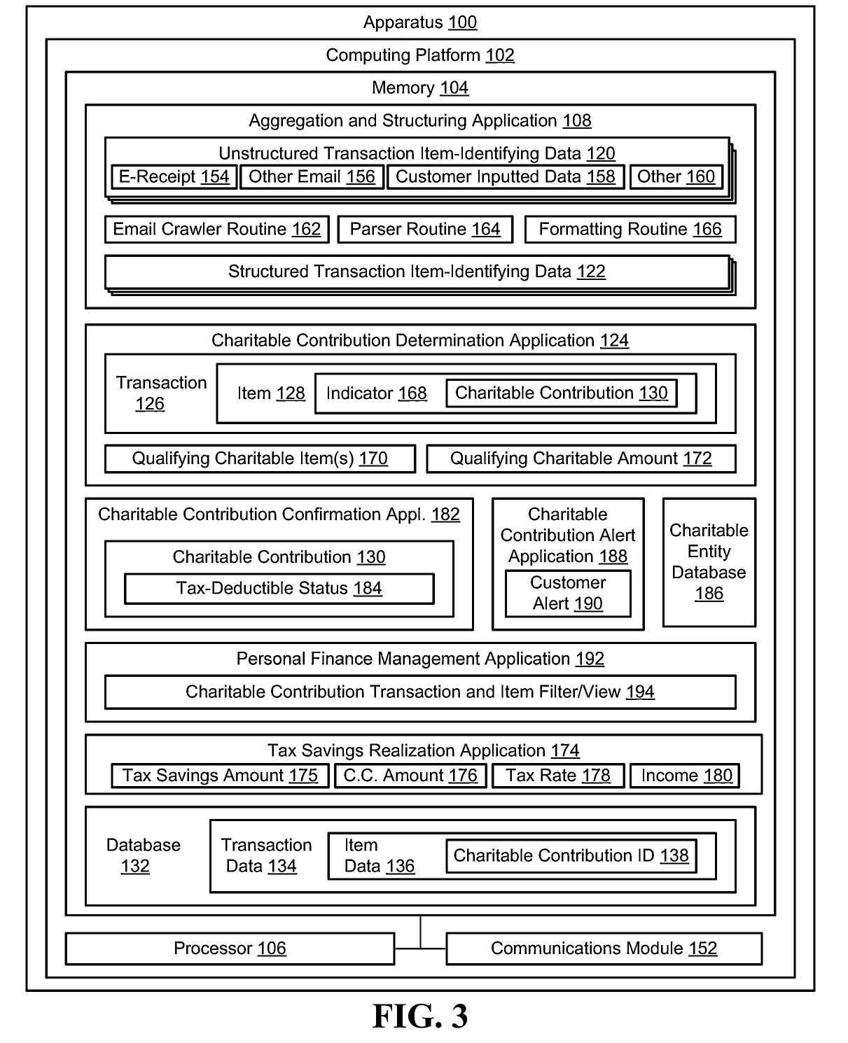

Referring to FIG. 3 shown is a more detailed block diagram of apparatus 100, according to embodiments of the present invention. As previously described, the apparatus 100 is configured to analyzed transaction item identifying data, such as e-receipts or the like to determine transactions or items in the transaction as charitable contributions. In addition to providing greater detail, FIG. 3 highlights various alternate embodiments of the invention. The apparatus 100 may include one or more of any type of computerized device. The present apparatus and methods can accordingly be performed on any form or combination of computing devices, including servers, personal computing devices, laptop/portable computing devices, mobile computing devices or the like.

The apparatus 100 includes computing platform 102 that can receive and execute routines and applications. Computing platform 102 includes memory 104, which may comprise volatile and non-volatile memory, such as read-only and/or random-access memory (RAM and ROM), EPROM, EEPROM, flash cards, or any memory common to computer platforms. Further, memory 104 may include one or more flash memory cells, or may be any secondary or tertiary storage device, such as magnetic media, optical media, tape, or soft or hard disk.

Further, computing platform 102 also includes processor 106, which may be an application-specific integrated circuit (“ASIC”), or other chipset, processor, logic circuit, or other data processing device. Processor 106 or other processor such as ASIC may execute an application programming interface (“API”) (not shown in FIG. 3) that interfaces with any resident programs, such as aggregation and structuring application 108, charitable contribution determination application 124, charitable contribution confirmation application 182, charitable contribution alert application 188, personal finance management application 192 or the like stored in the memory 104 of the apparatus 100.

Processor 106 may include various processing subsystems (not shown in FIG. 3) embodied in hardware, firmware, software, and combinations thereof, that enable the functionality of apparatus 100 and the operability of the apparatus on a network. For example, processing subsystems allow for initiating and maintaining communications and exchanging data with other networked devices. For the disclosed aspects, processing subsystems of processor 106 may include any subsystem used in conjunction with aggregation and structuring application 108, charitable contribution determination application 124, charitable contribution confirmation application 182, charitable contribution alert application 188, personal finance management application 192 or subcomponents or sub-modules thereof.

Computer platform 102 additionally includes communications module 152 embodied in hardware, firmware, software, and combinations thereof, that enables communications among the various components of the apparatus 100, as well as between the other devices in the transaction system, the aggregation and structuring system and/or the financial institution system. Thus, communication module 152 may include the requisite hardware, firmware, software and/or combinations thereof for establishing a network communication connection and initiating communication amongst networked devices.

As previously noted, the memory 104 of computing platform 102 stores aggregation and structuring application 108 that is executable by processor 106 and configured to receive unstructured transaction identifying-data 120, such as e-receipts 154, (e.g., purchase confirmations, shipping confirmations), other relevant emails 156, customer inputted data 158 (e.g., scanned hard-copy receipts or manually inputted hard copy receipt data) and any other data indicating a transaction conducted by the customer and the items included in the transaction 126, and process the data to result in structured transaction item-identifying data 122. In specific embodiments of the invention, the aggregation and structuring application 108 includes email crawler routine 162 that is configured to crawl email accounts(s) of the customer to identify and collect emails containing transaction data. Details of the email crawler routine 162 are discussed in relation to FIG. 1. The emails that are collected, which are herein collectively referred to as e-receipts, may include, but are not limited to, purchase confirmations, shipping confirmations, and any other emails including indicating a transaction and/or the items included in the transaction.

The aggregation and structuring application 108 may additionally include parser routine 164 that is configured to implement predetermined templates to parse relevant data from the unstructured transaction item-identifying data 120. As discussed in detail in relation to FIG. 1, the predetermined templates may be configured to parse data such as, but not limited to, merchant name, merchant contact information, transaction location (i.e., physical location or online), item identifiers, such as SKUs, UPCs or the like, item names, item amount, total purchase amount, tax amount, data and time or transaction, shipping information and the like.

The aggregation and structuring application 108 may additionally include formatting routine 166 that is configured to format the parsed data into a format that is compatible and/or accessible to financial institutions. For example, in specific embodiments, the parsed data may be formatted to conform to Open Financial Exchange “OFX” specifications for the electronic exchange of financial data between financial institutions, businesses and customers via the Internet. Once parsed and formatted, the structured transaction item-identifying data 122 may be stored in a requisite database (not shown in FIG. 3) for subsequent access by the financial institution or other entities authorized by the customer to have access to such transaction item-identifying data.

As previously discussed in relation to FIG. 2, memory 104 of apparatus 108 includes charitable contribution determination application 124 that is executable by the processor 106 and configured to determine, from the structured transaction item-identifying data 122, that the transaction 126 or one or more of the items 128 in the transaction 126 is/are charitable contributions 130. In one embodiment keyword searches are applied to the structured transaction item-identifying database, such as e-receipt data (e.g., purchase confirmations, shipping confirmations or the like) to identify transactions 126 or items 128 in transactions 126 that are charitable contributions 130.

In additional embodiments of the invention, the charitable contribution determination application 124 may be configured to determine the qualifying charitable item or items 170 in those instances in which the entirety of the transaction does not qualify as a charitable contribution. In such embodiments, the structured transaction-item identifying data, e.g., the e-receipt or the like, may specifically state which item(s) qualify as charitable contributions or the user/customer may alter the e-receipt (e.g., amend the subject line or forward the e-receipt back to the customer's email account with comments in the email body) to indicate which item(s) qualify as charitable contributions. In other embodiments of the invention, in which the transaction item-identifying data does not indicate which item(s) qualify as charitable contributions the charitable contribution determination application 124 may be configured to access a rules database (not shown in FIG. 3) to make a rules-based determination as to which item(s) qualify as charitable contributions. The rules database may take into account current federal, state and/or local regulations regarding rules related to items qualifying as charitable contributions.

In additional embodiments of the invention, the charitable contribution determination application 124 may be configured to determine the amount of the transaction or the items in the transaction that qualify as a charitable amount for tax-deduction purposes. In such embodiments, the structured transaction-item identifying data, e.g., the e-receipt or the like, may specifically state the qualifying amount or the user/customer, aware of the qualifying amount, may alter the e-receipt (e.g., amend the subject line or forward the e-receipt back to the customer's email account with comments in the email body) to indicate the qualifying amount. In other embodiments of the invention, in which the transaction item-identifying data does not indicate the qualifying amount the charitable contribution determination application 124 may be configured to access a rules database (not shown in FIG. 3) to make a rules-based determination as to the qualifying amount. The rules database may take into account current federal, state and/or local regulations regarding rules related to qualifying items and the amount that qualifies for the purposes of tax-deduction.

In still further embodiments of the invention, the memory 104 of apparatus 100 stores charitable contribution confirmation application 182 that is executable by processor 106 and configured to, in response to determining that a transaction or item is a charitable contribution, access a charitable entity database 186 to confirm (i.e., verify) the tax-deductible status 184 of the charitable contribution 130. In certain embodiments, for example, when the transaction item-identifying data, such as an e-receipt, specifically states that the transaction or item qualifies as a charitable contribution 130, e.g., provides a qualifying federal tax identification number or the like, there may not be need to confirm/verify that the tax-deductible status 184 of the charitable contribution 130.

In additional embodiments of the invention, the memory 104 of apparatus 100 stores charitable contribution alert application 188 that is executable by the processor 106 and may be configured to generate and initiate communication of a customer alert 190 the notifies the customer that (a) a charitable contribution has been determined, along with the qualifying item(s) and amount, when applicable, or (b) a charitable contribution has been confirmed/verified, or (c) a charitable contribution which has been determined has failed to be confirmed/verified. In the event that the alert is configured to notify the customer that the charitable contribution has failed to be confirmed/verified, the alert may additionally be configured to state additional information required for confirming the charitable contribution or to assist in confirming the charitable confirmation. The additional information may include, but is not limited to, the name of the charitable entity, the address of the charitable entity, the federal tax identification number/employer identification number (EIN) or the like. The alert may also be configured to notify the customer that information regarding the charitable contribution is being forwarded to a customer-requested third party (e.g., tax information database, tax application database, tax advisor/preparer or the like) or query the customer as to whether the customer desires that information regarding the charitable contribution be forwarded to a predetermined or currently designated third party entity.

In still further specific embodiments of the invention, the memory 104 of apparatus 100 stores personal finance management application 192, such as on online banking application, mobile banking application or the like, which is executable by the processor 106 and configured to match the transactions 126 associated with the structured transaction item-identifying data 122 with transactions indicated in the application 192 and provide charitable contribution filtering 194 at the transaction and/or item levels. The filtering 194 is configured to provide views of which transactions and/or items are charitable contributions. In addition, the views provide for other information, such as, but not limited to, the qualifying items for charitable contribution; the qualifying amount of the charitable contribution; whether the charitable contribution has been confirmed/verified; whether, and to whom, information related to the charitable contribution has been forwarded to a third party entity and the like. In addition, the charitable contribution views 194 may be configured to highlight fields in which data is missing or unconfirmed, such as charitable amount, charitable entity name, address, federal tax identification number or the like.

Moreover, in alternate embodiments of the invention, the memory 104 of apparatus 106 stores tax savings realization application 174 that is executable by processor 106 and configured to determine an estimate of the tax savings amount 175 that is realized by the customer based on the charitable contribution. In this regard, the tax savings realization application 174 determines the tax saving amount 175 based on the charitable contribution amount 176 the income 180 of the customer (current year extrapolated or prior year) and the tax rate 178 of the customer (based on current year income extrapolated or prior year income). Once determined the tax savings amount may be included in a customer alert 190 or displayed in a charitable contribution transaction or item view 194 within a personal finance management application 192.

As previously discussed in relation to FIG. 2, memory 104 of apparatus 100 includes transaction database 132 that is configured to, in response to determine that a transaction or item(s) in a transaction structured transaction-item identifying data is/are charitable contributions, store a charitable contribution identifier 138 in conjunction with transaction data 134 associated with the transaction 126 that is a charitable contribution 130 or store individual charitable contribution identifiers 138 in conjunction with item data 136 for each item 128 in the transaction 126 that are charitable contributions. In such embodiment of the invention, the transaction database 132 is associated with a personal finance management application, such as online banking, mobile banking or the like. In such embodiments of the invention, a matching procedure may be necessary to match transactions existing in the personal finance management application (i.e., credit, checking transactions conducted by the customer) with the transaction associated with the transaction item-identifying data, e.g., the e-receipt or the like.

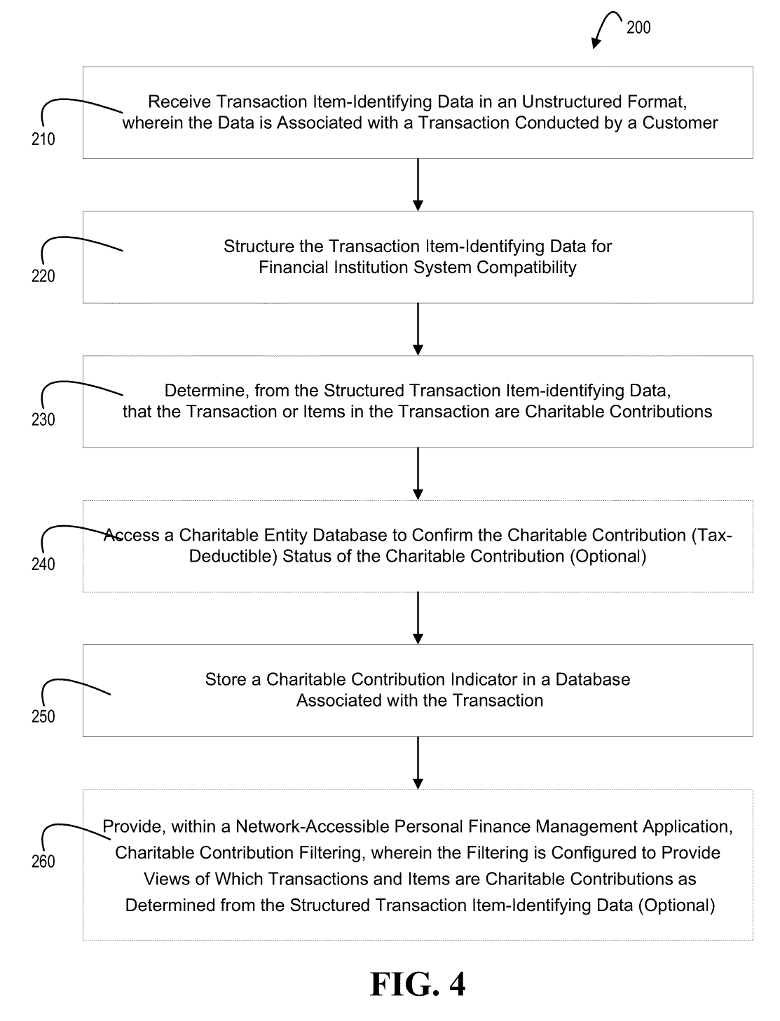

Referring to FIG. 4, a flow diagram of a method 200 for analyzing transaction item-identifying data, such as e-receipts or the like, to determine that the transaction and/or items in the transaction qualify as charitable contributions, in accordance with embodiments of the present invention. At Event 210, transaction item-identifying data is received in an unstructured format. The transaction item-identifying data is associated with a transaction conducted by the customer and may include e-receipts (e.g., purchase confirmation emails, shipping confirmation emails or the like), data from receipts scanned by the customer/user or manually inputted by the user/customer or data otherwise received or harvested form a merchant or customer. In specific embodiments of the invention, the transaction item-identifying data is received by crawling one or more email accounts associated with the customer to identify emails received that include the transaction item-identifying data (i.e., purchase confirmation emails, shipping confirmation emails or the like).

At Event 220, the unstructured transaction item-identifying data is structured for financial institution system capability. Structuring of the data may include applying a predetermined template to the data to parse or otherwise identify data that has been identified as relevant. The template(s) that is/are chosen to be applied to the data may be based on the form of the transaction item-identifying data, i.e., certain templates may apply to e-receipts, other templates may apply to customer inputted or scanned data. In addition to parsing data from the unstructured transaction item-identifying data, structuring the data may include reformatting the data to a format compatible with financial institution processing. For example, in specific embodiments, the data may be reformatted to conform to Open Financial Exchange “OFX” specifications for the electronic exchange of financial data between financial institutions, businesses and customers via the Internet. Once parsed and reformatted the structured data may be stored in associated database.

At Event 230, the structured transaction item-identifying data is used to determine that a transaction or item(s) in the transaction are charitable contributions. As previously noted, according to specific embodiments of the invention, the determination may be made by applying keyword searches to the structured transaction item-identifying database, such as e-receipt data (e.g., purchase confirmations, shipping confirmations or the like) to identify transactions 126 or items 128 in transactions 126 that are charitable contributions 130.

At optional Event 240, in response to determining that a transaction or item is a charitable contribution, a charitable entity database 186 is accessed to confirm (i.e., verify) the tax-deductible status of the charitable contribution. In certain embodiments, for example, when the transaction item-identifying data, such as an e-receipt, specifically states that the transaction or item qualifies as a charitable contribution 130, e.g., provides a qualifying federal tax identification number or the like, there may not be need to confirm/verify that the tax-deductible status 184 of the charitable contribution 130. In response to confirming the charitable contribution or failing to confirm the charitable contribution, an alert may be generated and communicated to the customer that is configured to notify the customer that either the charitable contribution has been confirmed/verified, or that a charitable contribution has failed to be confirmed/verified. In the event that the alert is configured to notify the customer that the charitable contribution has failed to be confirmed/verified, the alert may additionally be configured to state additional information required for confirming the charitable contribution or to assist in confirming the charitable confirmation. The additional information may include, but is not limited to, the name of the charitable entity, the address of the charitable entity, the federal tax identification number/employer identification number (EIN) or the like.

At Event 250, in response to determining that a transaction or item(s) in a transaction structured transaction-item identifying data is/are charitable contributions, a charitable contribution identifier 138 is stored in a transaction database in conjunction with transaction data associated with the transaction or in conjunction with item data for each item in the transaction that is a charitable contribution. In specific embodiments of the invention, the transaction database is associated with a personal finance management application, such as online banking, mobile banking or the like. In such embodiments of the invention, a matching event may be necessary to match transactions existing in the personal finance management application (i.e., credit, checking transactions conducted by the customer) with the transaction associated with the transaction item-identifying data, e.g., the e-receipt or the like.

At optional Event 260, a charitable contribution filter is provided within a network-accessible personal finance management application, such as online banking, mobile banking or the like. The filtering is configured to provide views of which transactions and/or items are charitable contributions. In addition, the views provide for other information, such as, but not limited to, the qualifying items for charitable contribution; the qualifying amount of the charitable contribution; whether the charitable contribution has been confirmed/verified; whether, and to whom, information related to the charitable contribution has been forwarded to a third party entity and the like. In addition, the charitable contribution views may be configured to highlight fields in which data is missing or unconfirmed, such as charitable amount, charitable entity name, address, federal tax identification number or the like.

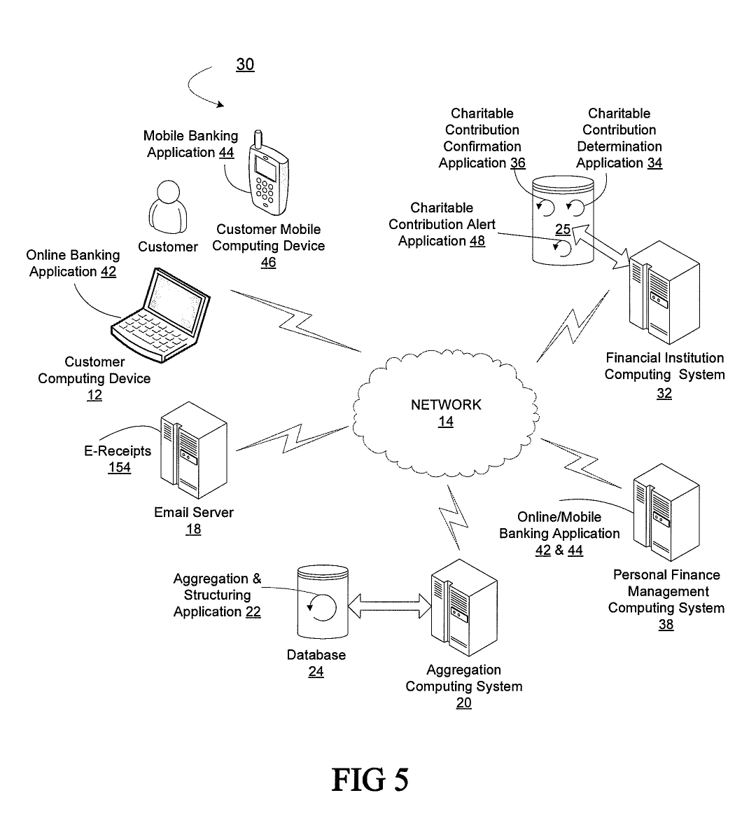

Referring to FIG. 5 a schematic diagram 30 is provided of a computing network environment for implementing embodiments of the present invention. The network 14 which serves as the communication hub may comprise any combination of one or more of the Internet, a wide area network, a local area network, a short range/near field network or any other form of contact or contactless network. The aggregation computing system 20 receives transaction item-identifying data in an unstructured format. The transaction item-identifying data is associated with a transaction conducted by the customer. In specific embodiments, the transaction item-identifying data are emails, such as e-receipts 154 obtained from crawling email accounts stored on email server 18. The aggregation computing system includes database 24 which stores aggregation and structuring application 22, which is configured to structure the unstructured transaction item-identifying data for financial institution compatibility. Structuring of the data may include parsing the unstructured data using predetermined templates and/or formatting the data to a format compatible with financial institution standards for communication and presentation. Once the data has been properly structured the data may be stored in database 24 or another database located on network 14.

Financial institution computing system 32 is in communication with database 25 and stores charitable contribution determination application 34 that is configured to determine, from the structured transaction item-identifying data stored in database 24, that the transaction or one or more of the items in the transaction is/are charitable contributions. In one embodiment keyword searches are applied to the structured transaction item-identifying database, such as e-receipt data (e.g., purchase confirmations, shipping confirmations or the like) to identify transactions or items in transactions that as charitable contributions.

In optional embodiments, the environment 30 may include personal finance management computing system 38 which may include a portion or all of financial institution computing system 32 or may be a separate entity of the financial institution or of a third party is configured to execute personal finance management applications, such as online banking application 42 or mobile banking application 44. The personal finance management application is configured to provide charitable contribution filtering at the transaction and/or item levels. The filtering is configured to present the customer, via customer computing device 12, which accesses online banking application 42 and customer mobile computing device 46, which accesses mobile banking application 44, with views of which transactions and/or items in the transaction qualify as charitable contributions. In addition, the views provide for other information, such as, but not limited to, the qualifying items for charitable contribution; the qualifying amount of the charitable contribution; whether the charitable contribution has been confirmed/verified; whether, and to whom, information related to the charitable contribution has been forwarded to a third party entity and the like. In addition, the charitable contribution views 194 may be configured to highlight fields in which data is missing or unconfirmed, such as charitable amount, charitable entity name, address, federal tax identification number or the like.

In optional embodiments of the invention database 25 may store charitable contribution confirmation application 36 that is configured to, in response to determining that a transaction or item is a charitable contribution, access a charitable entity database (not shown in FIG. 5) to confirm (i.e., verify) the tax-deductible status of the charitable contribution 130.

In additional embodiments of the invention database 25 may store charitable contribution alert application 48 that is configured to generate and initiate communication of a customer alert the notifies the customer that (a) a charitable contribution has been determined, along with the qualifying item(s) and amount, when applicable, or (b) a charitable contribution has been confirmed/verified, or (c) a charitable contribution which has been determined has failed to be confirmed/verified. In the event that the alert is configured to notify the customer that the charitable contribution has failed to be confirmed/verified, the alert may additionally be configured to state additional information required for confirming the charitable contribution or to assist in confirming the charitable confirmation.

Thus, the present invention as described in detail above, provides for analyzing transaction item-identifying data, such as e-receipts or the like for the purpose of identifying which transactions and/or items in a transaction qualify as charitable contributions. In addition to identifying which transactions and/or items qualify for charitable contributions specific embodiments of the present invention confirm that the charitable contribution is tax-deductible. Moreover additional embodiments of the invention determine the items and/or portion of the overall or item purchase amount that qualifies as a charitable contribution for tax deductions purposes. Additionally, the invention provides for automatically communicating verified charitable contribution information to a third party or database that will insure that the charitable contribution receives consideration when the customer's income tax filings are prepared. In this regard the present invention fully automates identification and of charitable contributions, verification/confirmation of such charitable contributions as being tax-deductible and insures that notification of such is communicated to customer designated entities that will insure inclusion of such in forthcoming income tax filings.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more general-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. An apparatus for automatically identifying charitable contributions in transaction item-identifying data, the apparatus comprising:
a computing platform having a memory and at least one processor in communication with the memory device;
an aggregation and structuring application stored in the memory, executable by the processor and configured to receive transaction item-identifying data in an unstructured format, wherein the transaction item-identifying data is associated with a transaction conducted by a customer, and structure the transaction item-identifying data for financial institution compatibility; and
a charitable contribution determination application stored in the memory, executable by the processor and configured to determine, from the structured transaction item-identifying data, that the transaction or one or more items in the transaction qualify as charitable contributions and store a charitable contribution identifier in a database associated with the transaction.

2. The apparatus of claim 1, wherein the aggregation and structuring application is further configured to receive an e-receipt corresponding to the transaction conducted by a customer, wherein the e-receipt includes one or more unique identifiers each of which identify an item in the transaction.

3. The apparatus of claim 2, wherein the aggregation and structuring application is further configured to crawl an email account held by the identified customer to identify and collect e-receipts received by the identified customer.

4. The apparatus of claim 1, wherein the charitable contribution determination application is further configured to determine that the structured transaction item-identifying data includes a charitable contribution indicator.

5. The apparatus of claim 1, further comprising a charitable contribution confirmation application stored in the memory, executable by the processor and configured to access a charitable entity database to attempt to confirm the tax-deductible status of the charitable contribution.

6. The apparatus of claim 5, further comprising a charitable contribution alert application stored in the memory, executable by the processor and configured to, in response to confirming or failing to confirm the tax-deductible status of the charitable contribution, generate and initiate communication of an alert to the customer, wherein the alert is configured to notify the customer that the charitable contribution is confirmed or unconfirmed.

7. The apparatus of claim 1, wherein the charitable contribution determination application is further configured to determine which of the one or more items in the transaction qualify as charitable contributions.

8. The apparatus of claim 1, wherein the charitable contribution determination application is further configured to determine an amount of the transaction that qualifies as a charitable contribution.

9. The apparatus of claim 1, further comprising a personal finance management application stored in the memory, executable by the processor and configured to provide charitable contribution transaction filtering, wherein the filtering is configured to provide a view of which transactions qualify as charitable contributions as determined from the structured transaction item-identifying data.

10. The apparatus of claim 1, wherein the charitable contribution determination application is further configured to communicate the transaction item-identifying data associated with the charitable contribution to at least one of an income tax application or an income tax advisor.

11. The apparatus of claim 1, wherein the charitable contribution determination application is further configured to determine a tax savings realized by the charitable contribution based on an amount of the charitable contribution, an income of the customer and a tax rate of the customer.

12. A method for automatically identifying charitable contributions in transaction item-identifying data, the method comprising:
receiving, by a computing device processor, transaction item-identifying data in an unstructured format, wherein the transaction item-identifying data is associated with a transaction conducted by a customer;
structuring, by a computing device processor, the transaction item-identifying data for financial institution compatibility;
determining, by a computing device processor, from the structured transaction item-identifying data, that the transaction or one or more items in the transaction qualify as charitable contributions; and
storing, by a computing device processor, a charitable contribution identifier in a database associated with the transaction

13. The method of claim 12, wherein receiving the transaction item-identifying data further comprises receiving an e-receipt corresponding to the transaction conducted by a customer, wherein the e-receipt includes one or more unique identifiers each of which identify an item in the transaction.

14. The method of claim 13, further comprising crawling, by a computing device processor, an email account held by the customer to identify and collect e-receipts received by the customer.

15. The method of claim 12, wherein determining, from the structured transaction item-identifying data, that the transaction or one or more items in the transaction qualify as charitable contributions further comprises determining that the structured transaction item-identifying data includes a charitable contribution indicator.

16. The method of claim 12, further comprising accessing, by a computing device processor, a charitable entity database to attempt to confirm the tax-deductible status of the charitable contribution.

17. The method of claim 16, further comprising, in response to failing to confirm the tax-deductible status of the charitable contribution, generating and initiating communication, by a computing device processor, of an alert to the customer, wherein the alert is configured to notify the customer that the charitable contribution is unconfirmed.

18. The method of claim 12, further comprising determining, by a computing device processor, which of the one or more items in the transaction qualify as charitable contributions.

19. The method of claim 12, further comprising determining, by a computing device processor, an amount of the transaction that qualifies as a charitable contribution.

20. The method of claim 12, further comprising providing, by a computing device processor, within a network-accessible financial institution application, charitable contribution transaction filtering, wherein the filtering is configured to provide a view of which transactions qualify as charitable contributions as determined from the structured transaction item-identifying data.

21. The method of claim 12, further comprising communicating, by a computing device processor, the transaction item-identifying data associated with the charitable contribution to at least one of an income tax application or an income tax advisor.

22. The method of claim 12, further comprising determining, by a computing device processor, tax savings realized by the charitable contribution based on an amount of the charitable contribution, an income of the customer and a tax rate of the customer.

23. A computer program product comprising:
a non-transitory computer-readable medium comprising:
a first set of codes for causing a computer to receive transaction item-identifying data in an unstructured format, wherein the transaction item-identifying data is associated with a transaction conducted by a customer;
a second set of codes for causing a computer to structure the transaction item-identifying data for financial institution compatibility;
a third set of codes for causing a computer to determine, from the structured transaction item-identifying data, that the transaction or one or more items in the transaction qualify as charitable contributions; and
a fourth set of codes for causing a computer to store a charitable contribution identifier in a database associated with the transaction.

24. The computer program product of claim 23, wherein the third set of codes is further configured to cause a computer to determine that the structured transaction item-identifying data includes a charitable contribution indicator.

25. The computer program product of claim 23, further comprising a fifth set of codes for causing a computer to access a charitable entity database to attempt to confirm the tax-deductible status of the charitable contribution.

26. The computer program product of claim 25, further comprising as sixth set of codes for causing a computer to, in response to confirming or failing to confirm the tax-deductible status of the charitable contribution, generate and initiate communication of an alert to the customer, wherein the alert is configured to notify the customer that the charitable contribution is confirmed or unconfirmed.

27. The computer program product of claim 23, further comprising a fifth set of codes for causing a computer to determine which of the one or more items in the transaction qualify as charitable contributions.

28. The computer program product of claim 23, further comprising a fifth set of codes for causing a computer to determine an amount of the transaction that qualifies as a charitable contribution.

29. The computer program product of claim 23, further comprising a fifth set of codes for causing a computer to provide, within a network-accessible financial institution application, charitable contribution transaction filtering, wherein the filtering is configured to provide a view of which transactions qualify as charitable contributions as determined from the structured transaction item-identifying data.
